(19) United States
(12) Patent Application Publication
(10) Pub. No.: US 2025/0384848 A1
(43) Pub. Date: Dec. 18, 2025

(54) DISPLAY DEVICE, METHOD OF DRIVING DISPLAY DEVICE, AND ELECTRONIC DEVICE

(71) Applicant: Samsung Display Co., Ltd., Yongin-si (KR)

(72) Inventors: Yun Mo CHUNG, Yongin-si (KR); Dae Woo LEE, Yongin-si (KR); Jun Ho PARK, Yongin-si (KR); Il Hun SEO, Yongin-si (KR)

(21) Appl. No.: 19/169,543

(22) Filed: Apr. 3, 2025

(30) Foreign Application Priority Data
Jun. 17, 2024 (KR) 10-2024-0078306
Sep. 19, 2024 (KR) 10-2024-0126925

(51) Int. Cl. G09G 3/3291

(52) U.S. Cl. CPC G09G 3/3291; G09G 2310/08; G09G 2320/0238

(57) ABSTRACT

A display device includes a display panel including sub-pixels; and a panel driver configured to sequentially apply data voltages to the sub-pixels in units of rows in an active period of one frame, and to perform a sensing operation on first sub-pixels emitting light of a first color among sub-pixels arranged on any one row among the sub-pixels in a blank period of the one frame, wherein the panel driver is configured to apply preliminary data voltages to the first sub-pixels before the sensing operation in the blank period.

### CROSS-REFERENCE TO RELATED APPLICATION

The present application claims priority to and the benefit of Korean Patent Application No. 10-2024-0078306, filed on Jun. 17, 2024, and Korean Patent Application No. 10-2024-0126925, filed on Sep. 19, 2024, in the Korean Intellectual Property, the entire disclosures of which are incorporated herein by reference.

### BACKGROUND

### 1. Field

Aspects of some embodiments of the present disclosure relate to a display device, a method of driving the display device, and an electronic device including the display device.

### 2. Description of the Related Art

With the development of information technologies, the importance of a display device, which is a connection medium between a user and information, has increased. Accordingly, various display devices, such as a liquid crystal display device and an organic light emitting display device, are increasingly being used.

The above information disclosed in this Background section is for enhancement of understanding of the background of the present disclosure, and therefore, it may contain information that does not constitute prior art.

### SUMMARY

Aspects of some embodiments of the present disclosure are directed to a display device having improved display quality, a method of driving the display device, and an electronic device including the display device.

According to some embodiments of the present disclosure, there is provided a display device including: a display panel including sub-pixels; and a panel driver configured to sequentially apply data voltages to the sub-pixels in units of rows in an active period of one frame, and to perform a sensing operation on first sub-pixels emitting light of a first color among sub-pixels arranged on any one row among the sub-pixels in a blank period of the one frame, wherein the panel driver is configured to apply preliminary data voltages to the first sub-pixels before the sensing operation in the blank period.

In some embodiments, the panel driver is configured to apply black data voltages to sub-pixels arranged on the same row as the first sub-pixels before the sensing operation in the blank period.

In some embodiments, the panel driver is further configured to apply the preliminary data voltages to second sub-pixels that are arranged on the same row as the first sub-pixels and emit light of a second color before the sensing operation in the blank period.

In some embodiments, the panel driver is configured to apply black data voltages to sub-pixels arranged on the same row as the first sub-pixels and the second sub-pixels before the sensing operation in the blank period.

In some embodiments, the panel driver is further configured to apply the preliminary data voltages to third sub-pixels that are arranged on the same row as the first sub-pixels and the second sub-pixels and emit light of a third color before the sensing operation in the blank period.

In some embodiments, the sub-pixels have a two-or-more-stack tandem structure.

According to some embodiments of the present disclosure, there is provided a method of driving a display device, the method including: sequentially driving sub-pixels in units of rows in an active period of one frame; driving first sub-pixels emitting light of a first color among sub-pixels arranged on any one row among the sub-pixels in a preliminary emission period of the one frame; and sensing the first sub-pixels in a sensing period of the one frame.

In some embodiments, a blank period of the one frame includes the preliminary emission period and the sensing period.

In some embodiments, in the driving of the first sub-pixels, sub-pixels arranged on the same row as the first sub-pixels are not driven.

In some embodiments, the method further includes driving second sub-pixels that are arranged on the same row as the first sub-pixels and emit light of a second color in the preliminary emission period, before the sensing the first sub-pixels.

In some embodiments, in the driving of the second sub-pixels, sub-pixels arranged on the same row as the first sub-pixels and the second sub-pixels are not driven.

In some embodiments, the method further includes driving third sub-pixels that are arranged on the same row as the first sub-pixels and the second sub-pixels and emit light of a third color in the preliminary emission period, before the sensing of the first sub-pixels.

In some embodiments, the sub-pixels have a two-or-more-stack tandem structure.

According to some embodiments of the present disclosure, there is provided an electronic device including: a processor configured to provide input image data; and a display device configured to display an image based on the input image data, the display device including: a display panel including sub-pixels; and a panel driver configured to sequentially drive the sub-pixels in units of rows in an active period of one frame, and to sense first sub-pixels emitting light of a first color among sub-pixels arranged on any one row among the sub-pixels in a sensing period of the one frame, the panel driver being configured to drive the first sub-pixels in a preliminary emission period between the active period and the sensing period.

In some embodiments, a blank period of the one frame includes the preliminary emission period and the sensing period.

In some embodiments, the panel driver does not drive sub-pixels arranged on the same row as the first sub-pixels in the preliminary emission period.

In some embodiments, the panel driver is further configured to drive second sub-pixels that are arranged on the same row as the first sub-pixels and emit light of a second color in the preliminary emission period.

In some embodiments, the panel driver does not drive sub-pixels arranged on the same row as the first sub-pixels and the second sub-pixels in the preliminary emission period.

In some embodiments, the panel driver is further configured to drive third sub-pixels that are arranged on the same row as the first sub-pixels and the second sub-pixels and emit light of a third color in the preliminary emission period.

In some embodiments, the sub-pixels have a two-or-more-stack tandem structure.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a block diagram of a display device according to some embodiments of the present disclosure.

FIG. 2 is a circuit diagram of a sub-pixel according to some embodiments of the present disclosure.

FIG. 3 is a conceptual diagram illustrating a driving timing of the display device according to some embodiments of the present disclosure.

FIG. 4 is a waveform diagram illustrating a method of driving the display device according to some embodiments of the present disclosure.

FIG. 5 is a diagram illustrating a state of a display panel in a blank period according to some embodiments of the present disclosure.

FIG. 6 is a sectional view of adjacent sub-pixels according to some embodiments of the present disclosure.

FIG. 7 is a diagram illustrating a state of the display panel in the blank period according to some embodiments of the present disclosure.

FIG. 8 is a waveform diagram illustrating a method of driving the display device according to some embodiments of the present disclosure.

FIGS. 9 to 12 are waveform diagrams each illustrating a method of driving the display device according to some embodiments of the present disclosure.

FIG. 13 is a diagram illustrating states of the display panel in a preliminary emission period and a sensing period according to some embodiments of the present disclosure.

FIG. 14 is a schematic block diagram illustrating an electronic device including a display device according to some embodiments of the present disclosure.

FIG. 15 is a schematic diagram illustrating an example where the electronic device of FIG. 14 is a smartphone.

FIG. 16 is a schematic diagram illustrating an example where the electronic device of FIG. 14 is a tablet computer.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

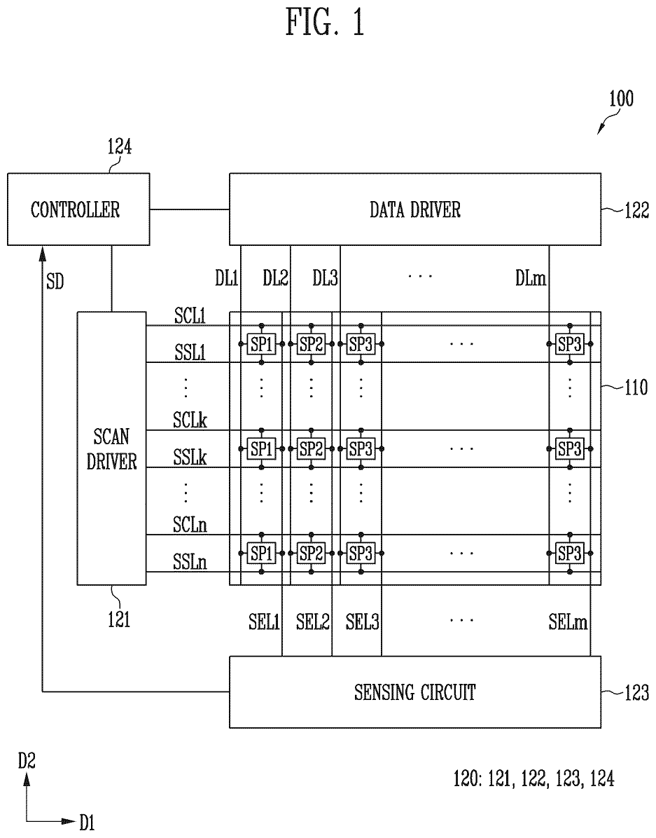

FIG. 1 is a block diagram of a display device according to some embodiments of the present disclosure.

Referring to FIG. 1, a display device 100 may include a display panel 110 and a panel driver 120.

The display panel 110 may include first sub-pixels SP1, second sub-pixels SP2, and third sub-pixels SP3. The first sub-pixels SP1, the second sub-pixels SP2, and the third sub-pixels SP3 may be arranged in a stripe form. For example, the first sub-pixels SP1, the second sub-pixels SP2, and the third sub-pixels SP3 may be alternately arranged along a first direction (or row direction) D1. Also, each of the first sub-pixels SP1, the second sub-pixels SP2, and the third sub-pixels SP3 may be successively arranged along a second direction (or column direction) D2. However, the arrangement form of the first sub-pixels SP1, the second sub-pixels SP2, and the third sub-pixels SP3 is not necessarily limited thereto.

The first sub-pixels SP1, the second sub-pixels SP2, and the third sub-pixels SP3 may be connected to first to nth scan lines SCL1 to SCLn. For example, first sub-pixels SP1, second sub-pixels SP2, and third sub-pixels SP3, which are arranged on a first row, may be connected to the first scan line SCL1. For example, first sub-pixels SP1, second sub-pixels SP2, and third sub-pixels SP3, which are arranged on a kth row, may be connected to a kth scan line SCLk. For example, first sub-pixels SP1, second sub-pixels SP2, and third sub-pixels SP3, which are arranged on an nth row, may be connected to the nth scan line SCLn.

The first sub-pixels SP1, the second sub-pixels SP2, and the third sub-pixels SP3 may be connected to first to nth sensing scan lines SSL1 to SSLn. For example, the first sub-pixels SP1, the second sub-pixels SP2, and the third sub-pixels SP3, which are arranged on the first row, may be connected to the first sensing scan line SSL1. For example, the first sub-pixels SP1, the second sub-pixels SP2, and the third sub-pixels SP3, which are arranged on the kth row, may be connected to a kth sensing scan line SSLk. For example, the first sub-pixels SP1, the second sub-pixels SP2, and the third sub-pixels SP3, which are arranged on the nth row, may be connected to the nth scan line SSLn.

The first sub-pixels SP1, the second sub-pixels SP2, and the third sub-pixels SP3 may be connected to first to mth data lines DL1 to DLm. For example, first sub-pixels SP1 arranged on a first column may be connected to the first data line DL1. For example, second sub-pixels SP2 arranged on a second column may be connected to the second data line DL2. For example, third sub-pixels SP3 arranged on a third column may be connected to the third data line DL3. For example, third sub-pixels SP3 arranged on an mth column may be connected to the mth data line DLm.

The first sub-pixels SP1, the second sub-pixels SP2, and the third sub-pixels SP3 may be connected to first to mth sensing lines SEL1 to SELm. For example, the first sub-pixels SP1 arranged on the first column may be connected to the first sensing line SEL1. For example, the second sub-pixels SP2 arranged on the second column may be connected to the second sensing line SEL2. For example, the third sub-pixels SP3 arranged on the third column may be connected to the third sensing line SEL3. For example, the third sub-pixels SP3 arranged on the mth column may be connected to the mth sensing line SELm.

The first sub-pixels SP1 may emit light of a first color, the second sub-pixels SP2 may emit light of a second color, and the third sub-pixels SP3 may emit light of a third color. For example, the first color may be red, the second color may be green, and the third color may be blue. However, embodiments of the present disclosure are not necessarily limited thereto.

The panel driver 120 may include a scan driver 121, a data driver 122, a sensing circuit 123, and a controller 124.

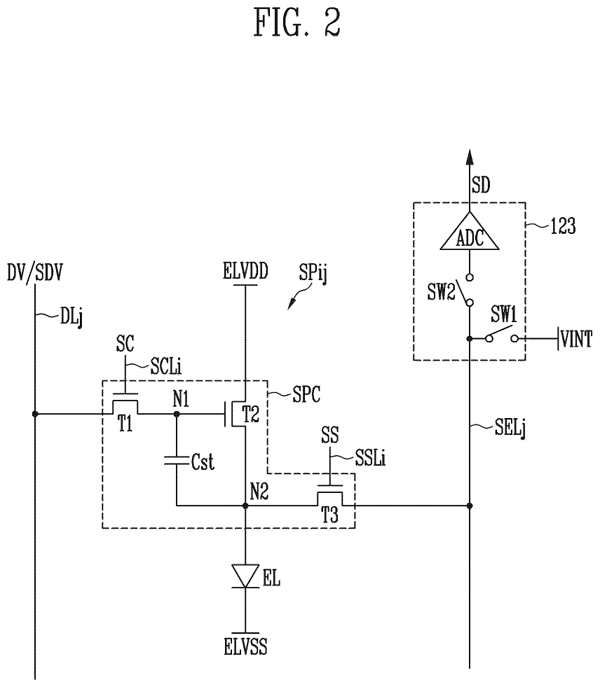

The scan driver 121 may be connected to the first to nth scan lines SCL1 to SCLn and the first to nth sensing scan lines SSL1 to SSLn. The scan driver 121 may sequentially provide scan signals SC (see, e.g., FIG. 2) to the first to nth scan lines SCL1 to SCLn in units of rows, based on a scan control signal provided from the controller 124. The scan driver 121 may sequentially provide sensing scan signals SS (see, e.g., FIG. 2) to the first to nth sensing scan lines SSL1 to SSLn in units of rows, based on a sensing scan control signal provided from the controller 124. The scan driver 121 may simultaneously provide a scan signal SC and a sensing scan signal SS in a unit of a row.

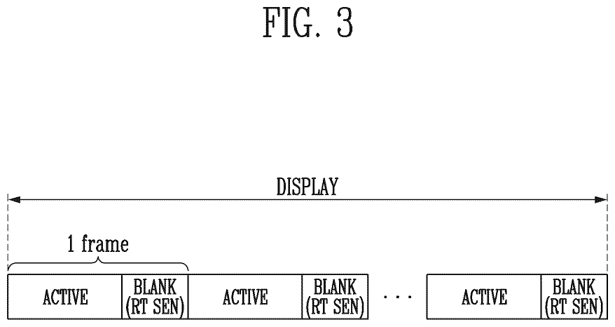

The data driver 122 may be connected to the first to mth data lines DL1 to DLm. The data driver 122 may generate data voltages DV (see, e.g., FIG. 2), based on output image data and a data control signal, which are provided from the controller 124. The data driver 122 may provide the data voltages DV to the first to mth data lines DL1 to DLm in an active period ACTIV (see, e.g., FIG. 3) of one frame (1 frame) (see, e.g., FIG. 3). For example, the data driver 122 may sequentially provide the data voltages DV to the first to mth data lines DL1 to DLm in synchronization with the scan signals SC in the active period ACTIVE of the one frame (1 frame).

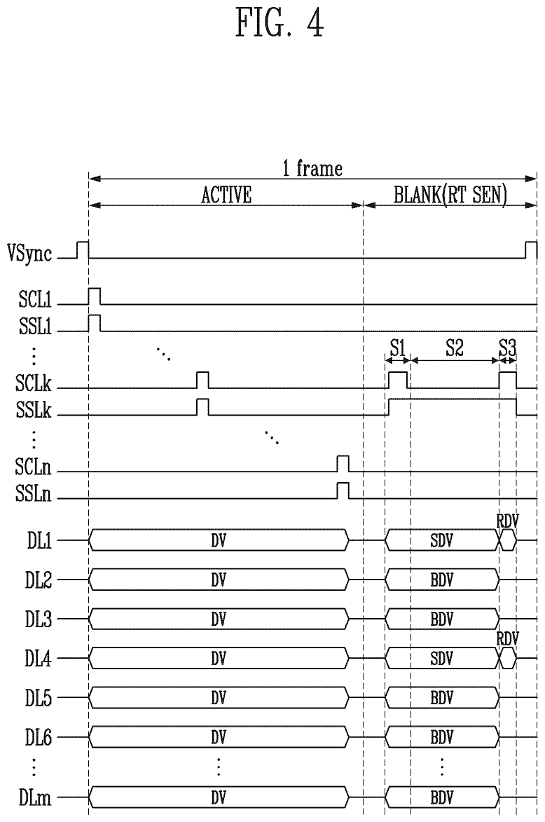

The data driver 122 may apply sensing data voltages SDV (see, e.g., FIG. 2) to sub-pixels that become sensing targets in a blank period BLANK (see, e.g., FIG. 4) of the one frame (1 frame). The sub-pixels that become the sensing targets may be arbitrarily selected. For example, arbitrary sub-pixels, e.g., the first sub-pixels SP1 among the first sub-pixels SP1, the second sub-pixels SP2, and the third sub-pixels SP3, which are arranged on the kth row, may be selected as targets on which a sensing operation is performed. The data driver 122 may apply the sensing data voltages SDV to the first sub-pixels SP1 arranged on the kth row, which are selected as the sensing targets, in the blank period BLANK of the one frame (1 frame). However, embodiments of the present disclosure are not necessarily limited thereto.

The data driver 122 may apply black data voltages BDV (see, e.g., FIG. 4) to sub-pixels that are not the sensing targets in the blank period BLANK of the one frame (1 frame). The sub-pixels that are not the sensing targets may mean sub-pixels arranged on the same row as the sub-pixels selected as the sensing targets. For example, the data driver 122 may apply the black data voltages BDV to the second sub-pixels SP2 and the third sub-pixels SP3, which are arranged on the kth row, in the blank period BLANK of the one frame (1 frame).

The sensing circuit 123 may be connected to the first to mth sensing lines SEL1 to SELm. The sensing circuit 123 may generate sensing data SD (see, e.g., FIG. 2) by sensing the sub-pixels selected as the sensing targets through the first to mth sensing line SEL1 to SELm. For example, the sensing circuit 123 may sense a driving characteristic (e.g., a threshold voltage) of second transistors T2 (see, e.g., FIG. 2) of the first sub-pixels SP1 arranged on the kth row. The sensing circuit 123 may be integrated separately from the data driver 122 in the display device 100, but embodiments of the present disclosure are not necessarily limited thereto. For example, the sensing circuit 123 may be integrated in the data driver 122 or the controller 124.

The controller 124 may receive input image data and a control signal, which are provided from an external host processor. The controller 124 may generate the scan control signal, the sensing scan control signal, and the data control signal, based on the control signal. The controller 124 may control the scan driver 121 through the scan control signal and the sensing scan control signal, and control the data driver 122 though the data control signal. The controller 124 may generate corrected output image data by correcting the input image data, based on the sensing data SD provided from the sensing circuit 123.

FIG. 2 is a circuit diagram of a sub-pixel according to some embodiments of the present disclosure. In FIG. 2, a circuit diagram of a sub-pixel SPij arranged on an ith row and a jth column is illustrated. The circuit diagram of the sub-pixel SPij may be equally applied to the first sub-pixels SP1, the second sub-pixels SP2, and the third sub-pixels SP3, which are shown in FIG. 1.

Referring to FIG. 2, the sub-pixel SPij may include a sub-pixel circuit SPC and a light emitting element EL. The sub-pixel circuit SPC may include a first transistor T1, a second transistor T2, a third transistor T3, and a storage capacitor Cst.

The storage capacitor Cst may store a data voltage DV or a sensing data voltage SDV, which is applied to a jth data line DLj. The storage capacitor Cst may include a first electrode connected to a first node N1 and a second electrode connected to a second node N2.

The first transistor T1 may connect the jth data line DLj to the first node N1 in response to a scan signal SC applied to an ith scan line SCLi. Accordingly, the data voltage DV or the sensing data voltage SDV may be applied to the first node N1. The first transistor T1 may include a gate electrode receiving the scan signal SC, a first electrode to the jth data line DLj, and a second electrode connected to the first node N1.

The second transistor T2 may generate a driving current, based on the data voltage DV stored in the storage capacitor Cst. Also, the second transistor T2 may generate a sensing current, based on the sensing data voltage SDV stored in the storage capacitor Cst. The sensing current may include information on a driving characteristic (e.g., a threshold voltage) of the second transistor T2. The second transistor T2 may include a gate electrode connected to the first node N1, a first electrode connected to a line of a first power voltage ELVDD, and a second electrode connected to the second node N2.

The third transistor T3 may connect a jth sensing line SELj to the second node N2 in response to a sensing scan signal applied to an ith sensing scan line SSLi. The third transistor T3 may include a gate electrode receiving the sensing scan signal SS, a first electrode connected to the jth sensing line SELj, and a second electrode connected to the second node N2.

The light emitting element EL may emit light in response to the driving current of the second transistor T2. The light emitting element EL may be an organic light emitting diode, but embodiments of the present disclosure are not necessarily limited thereto. The light emitting element EL may include an anode connected to the second node N2 and a cathode connected to a line of a second power voltage ELVSS. The sub-pixel SPij may be connected to the sensing circuit 123 through the jth sensing line SELj. The sensing circuit 123 may include a first switch SW1, a second switch SW2, and an analog-to-digital converter ADC.

The first switch SW1 may control a connection between a line of an initialization voltage VINT and the jth sensing line SELj. The second switch SW2 may control a connection between the analog-to-digital converter ADC and the jth sensing line SELj. For example, when the first switch SW1 is turned on (e.g., activated) and the second switch SW2 is turned off (e.g., deactivated), the initialization voltage VINT may be applied to the second node N2. For example, when the first switch SW1 is turned off and the second switch SW2 is turned on, the sensing current of the second transistor T2 may be provided to the analog-to-digital converter ADC. The analog-to-digital converter ADC may convert the sensing current of the second transistor T2 in an analog form into sensing data in a digital form.

FIG. 3 is a conceptual diagram illustrating a driving timing of the display device according to some embodiments of the present disclosure.

Referring to FIG. 3, the display device 100 (see, e.g., FIG. 1) may be driven in units of frames. One frame (1 frame) may include an active period ACTIVE and a blank period BLANK.

In the active period ACTIVE, as data voltages DV (see, e.g., FIG. 2) are applied to the first sub-pixels SP1 (see, e.g., FIG. 1), the second sub-pixels SP2 (see, e.g., FIG. 1), and the third sub-pixels SP3 (see, e.g., FIG. 1), the first sub-pixels SP1, the second sub-pixels SP2, and the third sub-pixels SP3 may emit light.

In the blank period BLANK, as sensing data voltages SDV (see, e.g., FIG. 2) may be applied to the first sub-pixels SP1 arranged on the kth row, a sensing operation may be performed. As such, that the sensing operation is performed in real time in a display period DISPLAY in which the display device 100 displays an image may be referred to as real-time sensing RT SEN (see, e.g., FIG. 4). That is, the real-time sensing RT SEN may be performed in the blank period BLANK.

In the blank period BLANK, as black data voltages BVD (see, e.g., FIG. 4) may be applied to the second sub-pixels SP2 and the third sub-pixels SP3 that are arranged on the kth row, the second sub-pixels SP2 and the third sub-pixels SP3 that are arranged on the kth row, may not emit light. Although the data voltages DV are not applied to first sub-pixels SP1, second sub-pixels SP2, and third sub-pixels SP3, which are arranged on the other rows except the kth row, the first sub-pixels SP1, the second sub-pixels SP2, and the third sub-pixels SP3, which are arranged on the other rows except the kth row, may maintain an emission state.

FIG. 4 is a waveform diagram illustrating a method of driving the display device according to some embodiments of the present disclosure.

Referring to FIG. 4, a vertical synchronization signal Vsync may be a signal for defining one frame (1 frame). For example, one cycle of the vertical synchronization signal Vsync may be set to the one frame (1 frame).

In an active period ACTIVE, scan signals SC (see, e.g., FIG. 2) having a high level may be sequentially supplied to the first to nth scan lines SCL1 to SCLn, and data voltages DV may be supplied to the first to mth data lines DL1 to DLm in synchronization with the scan signals SC having the high level. For example, the data voltage DV may be applied to the first node N1 (see, e.g., FIG. 2).

In the active period ACTIVE, sensing scan signals SS (see, e.g., FIG. 2) having a high level may be sequentially supplied to the first to nth sensing scan lines SSL1 to SSLn, the first switch SW1 (see, e.g., FIG. 2) may be turned on, and the second switch SW2 (see, e.g., FIG. 2) may be turned off. For example, as the initialization voltage VINT may be applied to the second node N2 (see, e.g., FIG. 2), the anode of the light emitting element EL (see, e.g., FIG. 2) may be initialized.

Therefore, a gate-source voltage of the second transistor T2 (see, e.g., FIG. 2) (or a voltage between the first node N1 and the second node N2) may become a difference between the data voltage DV and the initialization voltage VINT, and the storage capacitor Cst (see, e.g., FIG. 2) may store a voltage corresponding to the difference between the data voltage DV and the initialization voltage VINT.

In the active period ACTIVE, when the scan signals SC and the sensing scan signals SS have a low level, and the first switch SW1 and the second switch SW2 are turned off, a driving current corresponding to the gate-source voltage of the second transistor T2 may be generated as the first power voltage ELVDD is applied to the first electrode of the second transistor T2. As the driving current of the second transistor T2 flows through the light emitting element EL, the light emitting element EL may emit light.

The blank period BLANK in which the real-time sensing RT SET is performed may include a first period S1, a second period S2, and a third period S3.

In the first period S1, a scan signal SC having a high level may be supplied to the kth scan line SCLk. Sensing data voltages SDV may be supplied to data lines DL1, DL4, . . . connected to the first sub-pixels SP1 (see, e.g., FIG. 1) of the kth row, on which a sensing operation is performed, in synchronization with the scan signal SC having the high level. Black data voltages BDV may be supplied to data lines DL2, DL5, . . . connected to the second sub-pixels SP2 (see, e.g., FIG. 1) of the kth row, on which the sensing operation is not performed, in synchronization with the scan signal SC having the high level. Black data voltages BDV may be supplied to data lines DL3, DL6, . . . , and DLm connected to the third sub-pixels SP3 (see, e.g., FIG. 1) of the kth row, on which the sensing operation is not performed, in synchronization with the scan signal SC having the high level.

In the first period S1, a sensing scan signal SS having a high level may be supplied to the kth sensing scan line SSLk, the first switch SW1 may be turned on, and the second switch SW2 may be turned off. For example, as the initialization voltage VINT is applied to the second node N2, the second electrode of the second transistor T2 may be initialized.

Therefore, the gate-source voltage of the second transistor T2 (or the voltage between the first node N1 and the second node N2) may become a difference between the sensing data voltage SDV and the initialization voltage VINT, and the storage capacitor Cst may store a voltage corresponding to the difference between the sensing data voltage SDV and the initialization voltage VINT.

In the second period S2, the scan signal SC may have a low level, the sensing scan signal SS may have a high level, the first switch SW1 may be turned off, and the second switch SW2 may be turned on. For example, as the first power voltage ELVDD is applied to the first electrode of the second transistor T2, a sensing current corresponding to the gate-source voltage of the second transistor T2 may be generated. The sensing current may be applied to the sensing circuit 123 (see, e.g., FIG. 1) through the first sensing line SEL1 (see, e.g., FIG. 1) connected to the first sub-pixel SP1 on which the sensing operation is performed, and the sensing circuit 123 may generate a sensing data SD (see, e.g., FIG. 2) corresponding to the sensing current.

In the third period S3, the scan signal SC and the sensing scan signal SS may have a high level, the first switch SW1 may be turned on, and the second switch SW2 may be turned off. Recovery data voltages RDV may be supplied to the data lines DL1, DL4, . . . connected to the first sub-pixels SP1 on which the sensing operation is performed in synchronization with the scan signal SC having the high level. The recovery data voltages RDV may have the same voltage level as data voltages DV applied in a previous frame or data voltages DV applied in a next frame. Accordingly, a luminance change of the first sub-pixels SP1 on which the sensing operation is performed can be reduced.

In the blank period BLANK, a scan signal having a low level may be supplied to the other scan lines except the kth scan line SCLk. In the blank period BLANK, a sensing scan signal SS having a low level may be supplied to the other sensing scan lines except the kth sensing scan line SSLk.

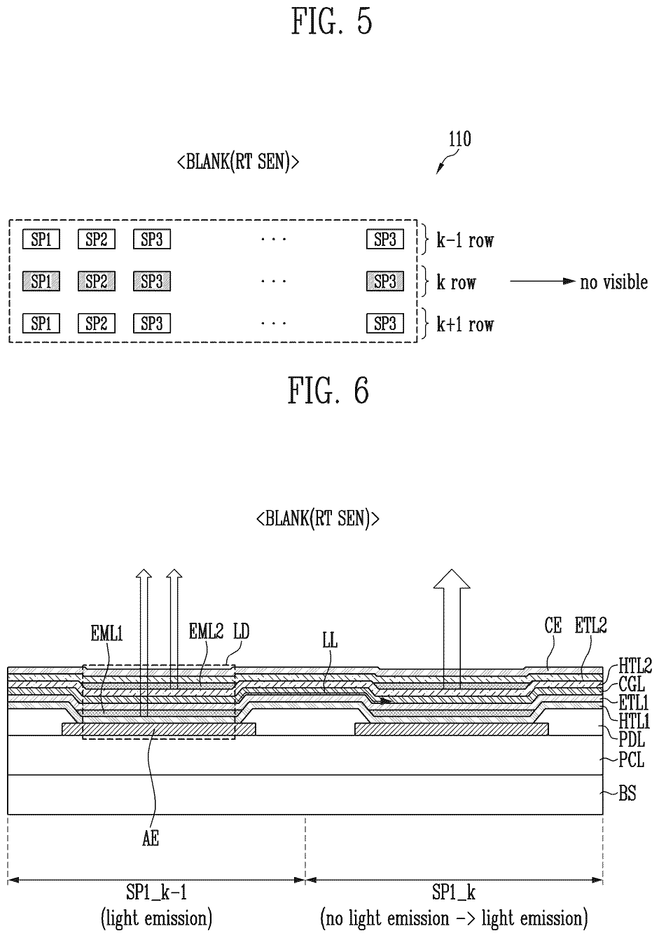

FIG. 5 is a diagram illustrating a state of the display panel in the blank period according to some embodiments of the present disclosure. In FIG. 5, the display panel 110 including first sub-pixels SP1, second sub-pixels SP2, and third sub-pixels SP3, which are arranged on the kth row, and a (k−1)th row and a (k+1)th row, which are adjacent to the kth row, is exemplarily illustrated.

Referring to FIG. 5, in the blank period BLANK in which the real-time sensing RT SEN is performed, the first sub-pixels SP1, the second sub-pixels SP2, and the third sub-pixels SP3, arranged on the kth row, on which the sensing operation is performed, may not emit light. In the blank period BLANK, first sub-pixels SP1, second sub-pixels SP2, and third sub-pixels SP3, arranged on rows, i.e., the (k−1)th row and the (k+1)th row, on which the sensing operation is not performed, may maintain an emission state. Accordingly, because the kth row has a low luminance as compared with the (k−1)th row and the (k+1)th row, which are adjacent to the kth row, in the display panel 110, the kth row appears in a dark line form, and is not viewable (e.g., by a user).

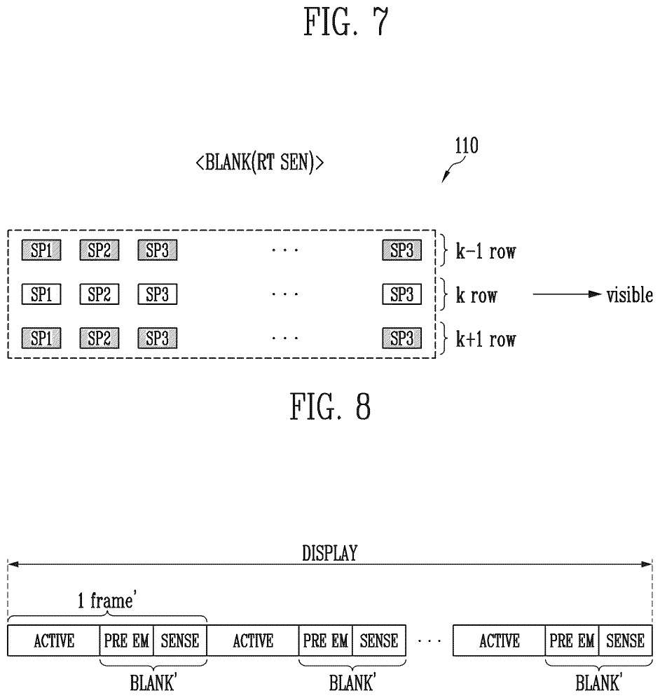

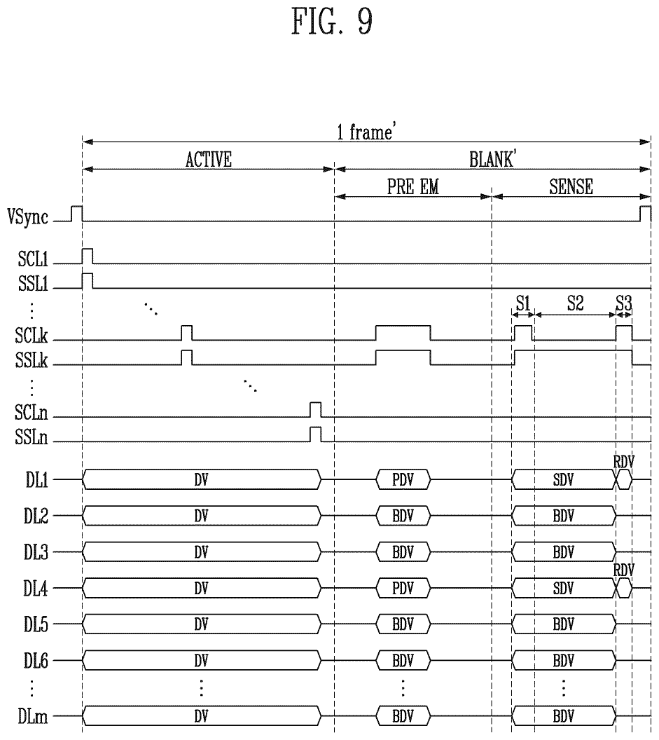

FIG. 6 is a sectional view of adjacent sub-pixels according to some embodiments of the present disclosure. FIG. 7 is a diagram illustrating a state of the display panel in the blank period according to some embodiments of the present disclosure.

In FIG. 6, a first sub-pixel SP1_k arranged on the kth row and a first sub-pixel SP1_k−1 arranged on the (k−1)th row adjacent to the kth row are exemplarily illustrated. A structure of the sub-pixels shown in FIG. 6 may be equally applied to the first sub-pixels SP1, the second sub-pixels SP2, and the third sub-pixels SP3, which are shown in FIG. 1.

Referring to FIG. 6, the first sub-pixels SP1_k and SP1_k−1 may have a two-stack tandem structure (e.g., a structure with two light emitting structures divided using a charge generation layer CGL as a boundary). However, embodiments of the present disclosure are not necessarily limited thereto. For example, the first sub-pixels SP1_k and SP1_k−1 may have a three-or-more-stack tandem structure.

A pixel circuit layer PCL may be disposed (e.g., positioned/located/arranged) on a base substrate BS. The base substrate BS may be a PI substrate, a glass substrate, or the like, but embodiments of the present disclosure are not necessarily limited thereto. For example, the base substrate BS may be a silicon substrate. The pixel circuit layer PCL may include sub-pixel circuits SPC (see, e.g., FIG. 2) of the first sub-pixels SP1 (see, e.g., FIG. 1), the second sub-pixels SP2 (see, e.g., FIG. 1), and the third sub-pixels SP3 (see, e.g., FIG. 1).

Anodes AE may be disposed on the pixel circuit layer PCL. The anodes AE may include an opaque conductive material capable of reflecting light, but embodiments of the present disclosure are not necessarily limited thereto. A pixel defining layer PDL may be disposed on the pixel circuit layer PCL, and be partially disposed on the anodes AE. The pixel defining layer PDL may be made of an organic insulating material or an inorganic insulating material.

A first hole transport layer HTL1 may be entirely provided on the anodes AE and the pixel defining layer PDL (e.g., the first hole transport layer HTL1 may cover an entirety of the anodes AE and the pixel defining layer PDL). The first hole transport layer HTL1 may function to smoothly transport holes provided from the anodes AE.

First light emitting layers EML1 may be disposed on the first hole transport layer HTL1. The first light emitting layers EML1 may be included in corresponding sub-pixels, respectively. The first light emitting layers EML1 may include a light emitting material emitting light of a first color (e.g., red).

A first electron transport layer ETL1 may be entirely provided on the first light emitting layers EML1 and the first hole transport layer HTL1 (e.g., the first electron transport layer ETL1 may cover an entirety of the first light emitting layers EML1 and the first hole transport layer HTL1). The first electron transport layer ETL1 may function to smoothly transport electrons provided from a charge generation layer CGL.

The charge generation layer CGL may be disposed on the first electron transport layer ETL1. The charge generation layer CGL may function to provide electrons to the first light emitting layers EML1 and provide holes to second light emitting layers EML2. For example, the charge generation layer CGL may include an n-type charge generation layer configured to provide electrons and a p-type charge generation layer configured to provide holes.

A second hole transport layer HTL2 may be disposed on the charge generation layer CGL. The second hole transport layer HTL2 may function to smoothly transport holes provided from the charge generation layer CGL.

The second light emitting layers EML2 may be disposed on the second hole transport layer HTL2. The second light emitting layers EML2 may be included in corresponding sub-pixels, respectively. The second light emitting layers EML2 may include a light emitting material emitting light of the same color as the first light emitting layers EML1. However, embodiments of the present disclosure are not necessarily limited thereto.

A second electron transport layer ETL2 may be entirely provided on the second light emitting layers EML2 and the charge generation layer CGL (e.g., the second electron transport layer ETL2 may cover an entirety of the second light emitting layers EML2 and the charge generation layer CGL). The second electron transport layer ETL2 may function to smoothly transport electrons provided from a cathode CE.

The cathode CE may be disposed on the second electron transport layer ETL2. The cathode CE may be formed of a metal material or be formed of a transparent conductive material.

A portion of the anode AE, a portion of the first hole transport layer HTL1 that overlaps with the portion of the anode AE, a portion of the first light emitting layer EML1 that overlaps with the portion of the first hole transport layer HTL1, a portion of the first electron transport layer ETL1 that overlaps with the portion of the first light emitting layer EML1, a portion of the charge generation layer CGL that overlaps with the portion of the first electron transport layer ETL1, a portion of the second hole transport layer HTL2 that overlaps with the portion of the charge generation layer CGL, a portion of the second light emitting layer EML2 that overlaps with the portion of the second hole transport layer HTL2, a portion of the second electron transport layer ETL2 that overlaps with the portion of the second light emitting layer EML2, and a portion of the cathode CE that overlaps with the portion of the second electron transport layer ETL2, may constitute a light emitting element LD. That is, the light emitting element LD may be a two-stack tandem element configured with two light emitting structures divided using the charge generation layer CGL as a boundary. However, embodiments of the present disclosure are not necessarily limited thereto. For example, the light emitting element LD may be a three-or-more-stack tandem element configured with three or more light emitting structures divided using two or more charge generation layers as boundaries.

In the blank period BLANK in which the real-time sensing RT SEN is performed, the first sub-pixel SP1_k−1 of the (k−1)th row, on which the sensing operation is not performed, may preferably emit light, and the first sub-pixel SP1_k of the kth row, on which the sensing operation is performed, may not preferably emit light. However, lateral leakage LL may occur, and therefore, the first sub-pixel SP1_k of the kth row may unintendedly emit light. For example, as a current may be leaked from the first sub-pixel SP1_k−1 of the (k−1)th row to the first sub-pixel SP1_k of the kth row, the first sub-pixel SP1_k of the kth row may abnormally emit light. In addition, as the lateral leakage LL progresses, the luminance of light emitted from the first sub-pixel SP1_k−1 of the (k−1)th row may be decreased, and the luminance of light emitted from the first sub-pixel SP1_k of the kth row may be increased.

Therefore, referring to FIG. 7, because the kth row has a high luminance as compared with the (k−1)th row and the (k+1)th row, which are adjacent to the kth row, in the display panel 110, the kth row may appear in a bright line form, and be viewable (e.g., by a user). That is, a horizontal line may be viewed while the real-time sensing RT SEN is performed, and therefore, display quality may be deteriorated.

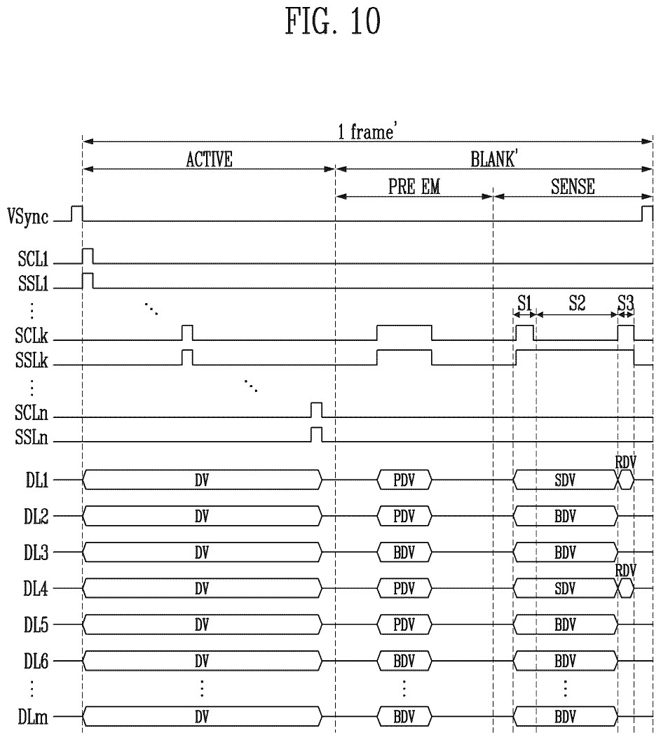

FIG. 8 is a waveform diagram illustrating a method of driving the display device according to some embodiments of the present disclosure.

Referring to FIG. 8, one frame (1 frame′) may include an active period ACTIVE and a blank period BLANK′. The blank period BLANK′ may include a preliminary emission period PRE EM and a sensing period SENSE. The sensing period SENSE may refer to a period in which the real-time sensing RT SEN (see, e.g., FIG. 3) is performed. Unlike FIG. 3, the preliminary emission period PRE EM may be inserted between the active period ACTIVE and the sensing period SENSE in which the real-time sensing RT SEN is performed.

In the preliminary emission period PRE EM, the first sub-pixels SP1 (see, e.g., FIG. 1) of the kth row, on which the sensing operation is performed, may emit light. In some embodiments, in the preliminary emission period PRE EM, the second sub-pixels SP2 (see, e.g., FIG. 1) of the kth row or the third sub-pixels SP3 (see, e.g., FIG. 1) of the kth row, on which the sensing operation is not performed, may additionally emit light. In some embodiments, in the preliminary emission period PRE EM, the second sub-pixels SP2 of the kth row and the third sub-pixels SP3 of the kth row, on which the sensing operation is not performed, may additionally emit light. An effect due to the insertion of the preliminary emission period PRE EM will be described later.

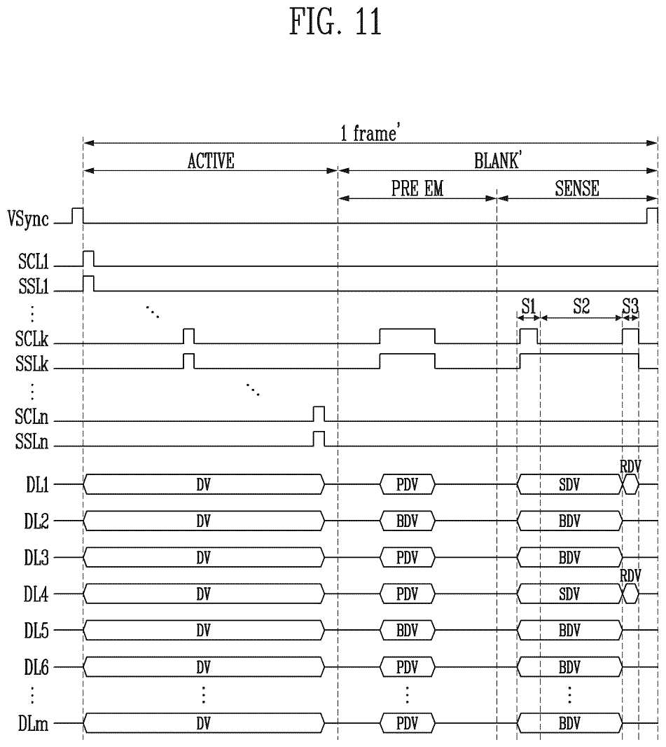

FIGS. 9 to 12 are waveform diagrams each illustrating a method of driving the display device according to some embodiments of the present disclosure. In FIGS. 9 to 12, descriptions of portions overlapping with the above-described portions may be simplified or omitted.

Referring to FIG. 9, in the preliminary emission period PRE EM, the panel driver 120 (see, e.g., FIG. 1) may drive the first pixels SP1 (see, e.g., FIG. 1) of the kth row, which are sensing targets.

For example, in the preliminary emission period PRE EM, the scan driver 121 (see, e.g., FIG. 1) may apply a scan signal SC (see, e.g., FIG. 2) having a high level to the kth scan line SCLK. Also, in the preliminary emission period PRE EM, the scan driver 121 may apply a sensing scan signal SS (see, e.g., FIG. 2) having a high level to the kth sensing scan line SSLK. Also, in the preliminary emission period PRE EM, the scan driver 121 may apply a scan signal SC having a low level to the other scan lines except the kth scan line SCLk. Also, in the preliminary emission period PRE EM, the scan driver 121 may apply a sensing scan signal SS having a low level to the other sensing scan lines except the kth sensing scan line SSLk.

For example, in the preliminary emission period PRE EM, the data driver 122 (see, e.g., FIG. 2) may apply preliminary data voltages PDV to the data lines DL1, DL4, . . . connected to the first sub-pixels SP1 of the kth row, which are the sensing targets, in synchronized with the scan signal SC having the high level. The preliminary data voltage PDV may have a voltage level at which the first sub-pixels SP1 of the kth row are driven with a low grayscale. That is, the first sub-pixels SP1 of the kth row may be driven to emit light with a luminance low enough not to be viewed by a user. For example, grayscales corresponding to the preliminary data voltage PDV may be smaller than grayscales corresponding to the data voltages DV.

In the preliminary emission period PRE EM, the data driver 122 may apply black data voltages BDV to the data lines DL2, DL5, . . . connected to the second sub-pixels SP2 (see, e.g., FIG. 1) of the kth row, which are not the sensing targets, in synchronization with the scan signal SC having the high level. Also, in the preliminary emission period PRE EM, the data driver 122 may apply black data voltages BDV to the data lines DL3, DL6, . . . , and DLm connected to the third sub-pixels SP3 (see, e.g., FIG. 1) of the kth row, which are not the sensing targets, in synchronization with the scan signal SC having the high level.

In the preliminary emission period PRE EM, the first sub-pixels SP1 of the kth row, which are the sensing targets, may emit light. Because the first sub-pixels SP1 of the kth row emit light, a current (or charges) leaked from the sub-pixels of the (k−1)th row and the (k+1)th row, which are adjacent to the kth row, to the first sub-pixels SP1 of the kth row can be reduced. That is, because the current flows through the first sub-pixels SP1 of the kth row, the quantity of charges charged in the first sub-pixels SP1 of the kth row due to a leakage current can be decreased. Accordingly, in the sensing period SENSE after the preliminary emission period PRE EM, influence due to the leakage current can be reduced, and thus, the luminance of light emitted from the first sub-pixels SP1 of the kth row can be decreased.

Referring to FIG. 10, in the preliminary emission period PRE EM, the panel driver 120 may drive the first sub-pixels SP1 (see, e.g., FIG. 1) of the kth row, which are sensing targets, and the second sub-pixels SP2 (see, e.g., FIG. 1) of the kth row, which are not the sensing targets.

For example, in the preliminary emission period PRE EM, the data driver 122 may apply preliminary data voltages PDV to the data lines DL1, DL4, . . . connected to the first sub-pixels SP1 of the kth row, which are the sensing targets, and the data lines DL2, DL5, . . . connected to the second sub-pixels SP2 of the kth row, which are not the sensing targets, in synchronization with the scan signal SC having the high level.

In the preliminary emission period PRE EM, the data driver 122 may apply black data voltages BDV to the data lines DL3, DL6, . . . , and DLm connected to the third sub-pixels SP3 (see, e.g., FIG. 1) of the kth row, which are not the sensing targets, in synchronization with the scan signal SC having the high level.

In the preliminary emission period PRE EM, the first sub-pixels SP1 of the kth row and the second sub-pixels SP2 of the kth row may emit light. Because the first sub-pixels SP1 of the kth row and the second sub-pixels SP2 of the kth row emit light, a current (or charges) leaked from the sub-pixels of the (k−1)th row and the (k+1)th row, which are adjacent to the kth row, to the first sub-pixels SP1 of the kth row and the second sub-pixels SP2 of the kth row can be further reduced. That is, because the current flows through the first sub-pixels SP1 of the kth row and the second sub-pixels SP2 of the kth row, the quantity of charges charged in the first sub-pixels SP1 of the kth row and the second sub-pixels SP2 of the kth row due to a leakage current can be further decreased. Accordingly, in the sensing period SENSE after the preliminary emission period PRE EM, influence due to the leakage current is further reduced, and thus, the luminance of light emitted from the first sub-pixels SP1 of the kth row and the second sub-pixels SP2 of the kth row can be further decreased.

Referring to FIG. 11, in the preliminary emission period PRE EM, the panel driver may drive the first sub-pixels SP1 (see, e.g., FIG. 1) of the kth row, which are sensing targets, and the third sub-pixels SP3 (see, e.g., FIG. 1) of the kth row, which are not the sensing targets.

For example, in the preliminary emission period PRE EM, the data driver 122 may apply preliminary data voltages PDV to the data lines DL1, DL4, . . . connected to the first sub-pixels SP1 of the kth row, which are the sensing targets, and the data lines DL3, DL6, . . . , and DLm connected to the second sub-pixels SP3 of the kth row, which are not the sensing targets, in synchronization with the scan signal SC having the high level.

In the preliminary emission period PRE EM, the data driver 122 may apply black data voltages BDV to the data lines DL2, DL5, . . . connected to the third sub-pixels SP2 (see, e.g., FIG. 1) of the kth row, which are not the sensing targets, in synchronization with the scan signal SC having the high level.

In the preliminary emission period PRE EM, the first sub-pixels SP1 of the kth row and the third sub-pixels SP3 of the kth row may emit light. Because the first sub-pixels SP1 of the kth row and the third sub-pixels SP3 of the kth row emit light, a current (or charges) leaked from the sub-pixels of the (k−1)th row and the (k+1)th row, which are adjacent to the kth row, to the first sub-pixels SP1 of the kth row and the third sub-pixels SP3 of the kth row can be further reduced. That is, because the current flows through the first sub-pixels SP1 of the kth row and the third sub-pixels SP3 of the kth row, the quantity of charges charged in the first sub-pixels SP1 of the kth row and the third sub-pixels SP3 of the kth row due to a leakage current can be further decreased. Accordingly, in the sensing period SENSE after the preliminary emission period PRE EM, influence due to the leakage current is further reduced, and thus, the luminance of light emitted from the first sub-pixels SP1 of the kth row and the third sub-pixels SP3 of the kth row can be further decreased.

Referring to FIG. 12, in the preliminary emission period PRE EM, the panel driver 120 may drive the first sub-pixels SP1 of the kth row, which are sensing targets, and the second sub-pixels SP2 of the kth row and the third sub-pixels SP3 of the kth row, which are not the sensing targets. That is, in the preliminary emission period PRE EM, the panel driver 120 may drive all the sub-pixels arranged on the kth row.

For example, in the preliminary emission period PRE EM, the data driver 122 may apply preliminary data voltages PDV to the data lines DL1, DL4, . . . connected to the first sub-pixels SP1 of the kth row, which are the sensing targets, the data lines DL2, DL5, . . . connected to the second sub-pixels SP2 of the kth row, which are not the sensing targets, and the data lines DL3, DL6, . . . , and DLm connected to the third sub-pixels SP3 of the kth row, which are not the sensing targets, in synchronization with the scan signal SC having the high level.

In the preliminary emission period PRE EM, the first sub-pixels SP1 of the kth row, the second sub-pixels SP2 of the kth row, and the third sub-pixels SP3 of the kth row may emit light. Because the first sub-pixels SP1 of the kth row, the second sub-pixels SP2 of the kth row, and the third sub-pixels SP3 of the kth row emit light, a current (or charges) leaked from the sub-pixels of the (k−1)th row and the (k+1)th row, which are adjacent to the kth row, to the first sub-pixels SP1 of the kth row, the second sub-pixels SP2 of the kth row, and the third sub-pixels SP3 of the kth row can be more effectively reduced. That is, because the current flows through the first sub-pixels SP1 of the kth row, the second sub-pixels SP of the kth row, and the third sub-pixels SP3 of the kth row, the quantity of charges charged in the first sub-pixels SP1 of the kth row, the second sub-pixels SP2 of the kth row, and the third sub-pixels SP3 of the kth row due to a leakage current can be more effectively decreased. Accordingly, in the sensing period SENSE after the preliminary emission period PRE EM, influence due to the leakage current is more effectively reduced, and thus, the luminance of light emitted from the first sub-pixels SP1 of the kth row, the second sub-pixels SP1 of the kth row, and the third sub-pixels SP3 of the kth row can be more effectively decreased.

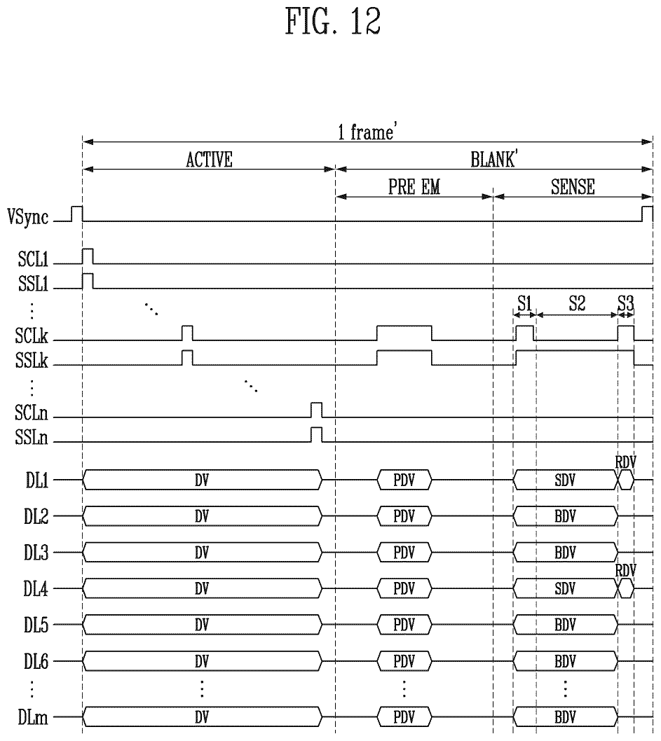

FIG. 13 is a diagram illustrating states of the display panel in the preliminary emission period and the sensing period according to some embodiments of the present disclosure.

Referring to FIGS. 9 and 13, in the preliminary emission period PRE EM, as the first sub-pixels SP1 arranged on the kth row, which are sensing targets, emit light with a low grayscale, the first sub-pixels SP1 arranged on the kth row may have a low luminance as compared with the sub-pixels arranged on the (k−1)th row and the (k+1)th row. Also, in the preliminary emission period PRE EM, the second sub-pixels SP2 and the third sub-pixels SP3, arranged on the kth row, which are not the sensing targets, may not emit light. Accordingly, in the display panel 110, because the kth row has a low luminance as compared with the (k−1)th row and the (k+1)th row, the kth row appears in a dark line form, and is not viewable (e.g., by a user).

Referring to FIGS. 10 and 13, in the preliminary emission period PRE EM, as the first sub-pixels SP1 arranged on the kth row (which are sensing targets) and the second sub-pixels SP2 arranged on the kth row (which are not the sensing targets) emit light with a low grayscale, the first sub-pixels SP1 and the second sub-pixels SP2 (which are arranged on the kth row) may have a low luminance as compared with the sub-pixels arranged on the (k−1)th row and the (k+1)th row. Also, in the preliminary emission period PRE EM, the third sub-pixels SP3 arranged on the kth row, which are not the sensing targets, may not emit light. Accordingly, in the display panel 110, because the kth row has a low luminance as compared with the (k−1)th row and the (k+1)th row, the kth row appears in a dark line form, and is not viewable (e.g., by a user).

Referring to FIGS. 11 and 13, in the preliminary emission period PRE EM, as the first sub-pixels SP1 arranged on the kth row (which are sensing targets) and the third sub-pixels SP3 arranged on the kth row (which are not the sensing targets) emit light with a low grayscale, the first sub-pixels SP1 and the third sub-pixels SP3 (which are arranged on the kth row) may have a low luminance as compared with the sub-pixels arranged on the (k−1)th row and the (k+1)th row. Also, in the preliminary emission period PRE EM, the second sub-pixels SP2 arranged on the kth row, which are not the sensing targets, may not emit light. Accordingly, in the display panel 110, because the kth row has a low luminance as compared with the (k−1)th row and the (k+1)th row, the kth row appears in a dark line form, and is not viewable (e.g., by a user).

Referring to FIGS. 12 and 13, in the preliminary emission period PRE EM, as the first sub-pixels SP1 arranged on the kth row (which are sensing targets) the second sub-pixels SP2 arranged on the kth row (which are not the sensing targets) and the third sub-pixels SP3 arranged on the kth row (which are not the sensing targets) emit light with a low grayscale, the first sub-pixels SP1, the second sub-pixels SP2, and the third sub-pixels SP3 (which are arranged on the kth row) may have a low luminance as compared with the sub-pixels arranged on the (k−1)th row and the (k+1)th row. Accordingly, in the display panel 110, because the kth row has a low luminance as compared with the (k−1)th row and the (k+1)th row, the kth row appears in a dark line form, and is not viewable (e.g., by a user).

As described in FIGS. 9 to 12, at least one of the first sub-pixels SP1, the second sub-pixels SP2, and the third sub-pixels SP3, arranged on the kth row, which are selected as sensing targets, are driven before the sensing period SENSE, so that the influence of a leakage current introduced from the sub-pixels arranged on the (k−1)th row and the (k+1)th row can be reduced. Accordingly, in the sensing period SENSE, in the display panel 110, because the kth row has a low luminance as compared with the (k−1)th row and the (k+1)th row, the kth row appears in a dark line form, and is not viewable (e.g., by a user). That is, in the sensing period SENSE in which the real-time sensing RT SEN (see, e.g., FIG. 3) is performed, no horizontal line is viewed, and the display quality can be improved.

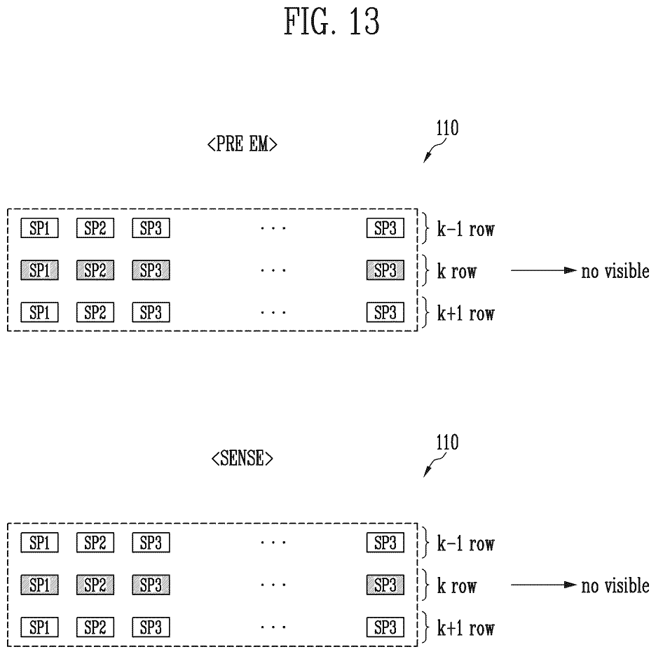

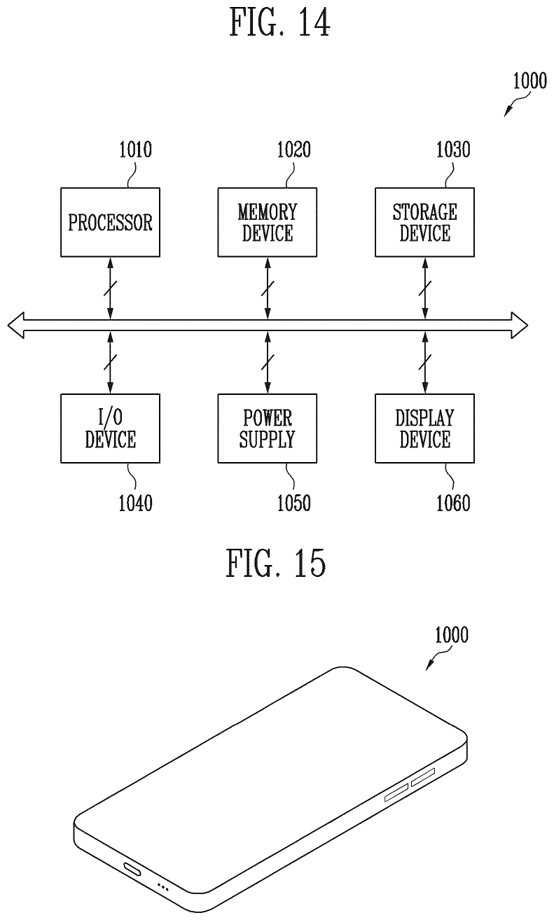

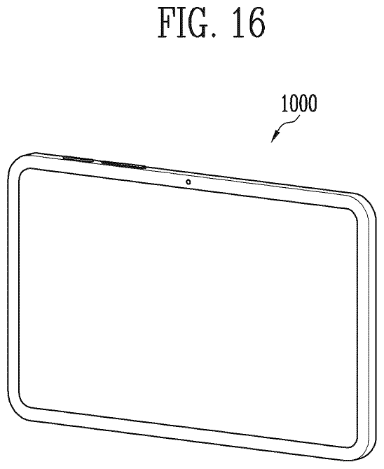

FIG. 14 is a schematic block diagram illustrating an electronic device including a display device according to some embodiments of the present disclosure. FIG. 15 is a schematic diagram illustrating an example where the electronic device of FIG. 14 is a smartphone. FIG. 16 is a schematic diagram illustrating an example where the electronic device of FIG. 14 is a tablet computer.

Referring to FIGS. 14 to 16, the electronic device 1000 may include a processor 1010, a memory device 1020, a storage device 1030, an input/output (I/O) device 1040, a power supply 1050, and a display device 1060. The display device 1060 may be the display device 100 of FIG. 1. The electronic device 1000 may further include various ports for communication with a video card, a sound card, a memory card, a USB device, or other systems. In some embodiments, as illustrated in FIG. 15, the electronic device 1000 may be a smartphone. In some embodiments, as illustrated in FIG. 16, the electronic device 1000 may be a tablet computer. However, the aforementioned examples are illustrative, and the electronic device 1000 is not necessarily limited to the aforementioned examples. For example, the electronic device 1000 may be a cellular phone, a video phone, a smart pad, a smartwatch, a navigation device for vehicles, a computer monitor, a laptop computer, a head-mounted display device, or the like.

The processor 1010 may perform specific calculations or tasks. In some embodiments, the processor 1010 may be a microprocessor, a central processing unit, an application processor, or the like. The processor 1010 may be connected to other components through an address bus, a control bus, a data bus, and the like. In some embodiments, the processor 1010 may be connected to an expansion bus such as a peripheral component interconnect (PCI) bus. In some embodiments, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device 1000 is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. In some embodiments, the display device 1060 may be integrated with the I/O device 1040.

The power supply 1050 may supply power needed to perform the operation of the electronic device 1000. For example, the power supply 1050 may include a power management integrated circuit (PMIC). In some embodiments, the power supply 1050 may supply power to the display device 1060.

The display device 1060 may display images in response to control signals or data from the processor 1010. The display device 1060 may be connected to other components through the buses or other communication links.

According to some embodiments, display quality can be prevented from being deteriorated as a horizontal line is viewed in a sensing period.

However, the aspects and features of the present disclosure are not limited to those described above, and various other aspects and features as would be understood by those having ordinary skill in the art may be included in the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A display device comprising:
a display panel comprising sub-pixels; and
a panel driver configured to sequentially apply data voltages to the sub-pixels in units of rows in an active period of one frame, and to perform a sensing operation on first sub-pixels emitting light of a first color among sub-pixels arranged on any one row among the sub-pixels in a blank period of the one frame,
wherein the panel driver is configured to apply preliminary data voltages to the first sub-pixels before the sensing operation in the blank period.

2. The display device of claim 1, wherein the panel driver is configured to apply black data voltages to sub-pixels arranged on the same row as the first sub-pixels before the sensing operation in the blank period.

3. The display device of claim 1, wherein the panel driver is further configured to apply the preliminary data voltages to second sub-pixels that are arranged on the same row as the first sub-pixels and emit light of a second color before the sensing operation in the blank period.

4. The display device of claim 3, wherein the panel driver is configured to apply black data voltages to sub-pixels arranged on the same row as the first sub-pixels and the second sub-pixels before the sensing operation in the blank period.

5. The display device of claim 3, wherein the panel driver is further configured to apply the preliminary data voltages to third sub-pixels that are arranged on the same row as the first sub-pixels and the second sub-pixels and emit light of a third color before the sensing operation in the blank period.

6. The display device of claim 1, wherein the sub-pixels have a two-or-more-stack tandem structure.

7. A method of driving a display device, the method comprising:
sequentially driving sub-pixels in units of rows in an active period of one frame;
driving first sub-pixels emitting light of a first color among sub-pixels arranged on any one row among the sub-pixels in a preliminary emission period of the one frame; and
sensing the first sub-pixels in a sensing period of the one frame.

8. The method of claim 7, wherein a blank period of the one frame comprises the preliminary emission period and the sensing period.

9. The method of claim 7, wherein, in the driving of the first sub-pixels, sub-pixels arranged on the same row as the first sub-pixels are not driven.

10. The method of claim 7, further comprising driving second sub-pixels that are arranged on the same row as the first sub-pixels and emit light of a second color in the preliminary emission period, before the sensing the first sub-pixels.

11. The method of claim 10, wherein, in the driving of the second sub-pixels, sub-pixels arranged on the same row as the first sub-pixels and the second sub-pixels are not driven.

12. The method of claim 10, further comprising driving third sub-pixels that are arranged on the same row as the first sub-pixels and the second sub-pixels and emit light of a third color in the preliminary emission period, before the sensing of the first sub-pixels.

13. The method of claim 7, wherein the sub-pixels have a two-or-more-stack tandem structure.

14. An electronic device, comprising:
a processor configured to provide input image data; and
a display device configured to display an image based on the input image data, the display device comprising:
a display panel comprising sub-pixels; and
a panel driver configured to sequentially drive the sub-pixels in units of rows in an active period of one frame, and to sense first sub-pixels emitting light of a first color among sub-pixels arranged on any one row among the sub-pixels in a sensing period of the one frame, the panel driver being configured to drive the first sub-pixels in a preliminary emission period between the active period and the sensing period.

15. The electronic device of claim 14, wherein a blank period of the one frame comprises the preliminary emission period and the sensing period.

16. The electronic device of claim 14, wherein the panel driver does not drive sub-pixels arranged on the same row as the first sub-pixels in the preliminary emission period.

17. The electronic device of claim 14, wherein the panel driver is further configured to drive second sub-pixels that are arranged on the same row as the first sub-pixels and emit light of a second color in the preliminary emission period.

18. The electronic device of claim 17, wherein the panel driver does not drive sub-pixels arranged on the same row as the first sub-pixels and the second sub-pixels in the preliminary emission period.

19. The electronic device of claim 17, wherein the panel driver is further configured to drive third sub-pixels that are arranged on the same row as the first sub-pixels and the second sub-pixels and emit light of a third color in the preliminary emission period.

20. The electronic device of claim 14, wherein the sub-pixels have a two-or-more-stack tandem structure.
